(19) United States
(12) Patent Application Publication
(10) Pub. No.: US 2015/0106208 A1
(43) Pub. Date: Apr. 16, 2015

(54) Social Parameter-Based Application Audiences

(71) Applicant: Adobe Systems Incorporated, San Jose, CA (US)

(72) Inventors: Jonathan Lancar, Redwood City, CA (US); Chad Michael Krsek, San Francisco, CA (US); Andrew Michael Boylan, Oakland, CA (US)

(73) Assignee: Adobe Systems Incorporated, San Jose, CA (US)

(21) Appl. No.: 14/055,682

(22) Filed: Oct. 16, 2013

(51) Int. Cl. G06Q 30/02; G06Q 50/00

(52) U.S. Cl. CPC G06Q 30/0269; G06Q 50/01
USPC 705/14.66

(57) ABSTRACT

Techniques for social parameter-based application audiences are described. In one or more embodiments, an audience is defined based on one or more social parameters. The audience can be associated with one or more objects in an application. A layout of content in the application can be defined based on the audience. The content can include the one or more objects that are associated with the audience, and the layout of content can be configured to be presented for display to a user of the application that has a social parameter that corresponds to the audience.

### BACKGROUND

Social media platforms provide application developers with a tremendous amount of data that is directly actionable. In one example, social networking data can be used to offer targeted advertisements to users, such as via a link to a specific experience. However, traditional techniques that were employed to enable advertisers to serve targeted advertisements to users may become inefficient for some applications as the amount of actionable data increases.

### SUMMARY

Techniques for social parameter-based application audiences are described. In one or more embodiments, an audience is defined based on one or more social parameters. The audience can be associated with one or more objects in an application. A layout of content in the application can be defined based on the audience. The content can include the one or more objects that are associated with the audience, and the layout of content can be configured to be presented for display to a user of the application that has a social parameter corresponding to the audience.

In at least one embodiment, one or more social parameters of a user of a social media platform are identified. The one or more social parameters can be used to determine an audience corresponding to the user. Then, content associated with the audience can be presented via an application.

In an embodiment, an application builder module can be configured to define multiple different layouts of content for an application where each layout corresponds to a respective audience. Each respective audience can be associated with one or more social parameters of users of a social media platform. Using these audiences, the application can be configured to provide different content to different users of the application based on the different users corresponding to different audiences.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques for social parameter-based application audiences.

FIG. 2 is an illustration of an example user interface employable by the audience manager module of FIG. 1 to create an application audience.

FIG. 3 is an illustration of an example user interface employable by the application builder module of FIG. 1 to define a layout of content for an application audience.

FIG. 4 is an illustration of an example user interface employable by the application builder module of FIG. 1 to define settings for objects in a layout of content for an application audience.

FIG. 5 is an illustration of an additional example user interface employable by the application builder module of FIG. 1 to define settings for objects in a layout of content for an application audience.

FIG. 6 is an illustration of an example user interface employable by the application builder module of FIG. 1 to define settings for objects in a layout of content for an additional application audience.

FIG. 7 is a flow diagram depicting a procedure in an example implementation in which techniques for social parameter-based application audiences are employed.

FIG. 8 is a flow diagram depicting a procedure in an example implementation in which techniques for social parameter-based application audiences are employed.

FIG. 9 illustrates various components of an example device that can be implemented as any type of computing device as described with reference to FIG. 1 to implement embodiments of the techniques described herein.

### DETAILED DESCRIPTION

### Overview

Conventional techniques that were used to enable advertisers to provide targeted advertisements to users may become inefficient for some applications as the amount of actionable data increases. For example, advertisers can target content, such as social media data, outside of an application and then provide a link to a specific experience. By performing the targeting outside of the application, the advertisers may have access to a tremendous amount of data, which is ever increasing. However, as the amount of data increases, the amount of time required to search through the data and locate desired content may increase, thereby causing user frustration.

Techniques involving social parameter-based application audiences are described. In the following discussion, a variety of different implementations are described that involve using social parameters to determine which content to provide to a user of a client device. In one example, during an application building phase, different layouts having different content can be associated with different audiences. These audiences can be based on one or more social parameters of users of a social network. Using these audiences, the user experience in the application may be customized to each user based on the respective user's social parameters of the social network. Consequently, application developers can direct a flow of the user experience to different screens, or modify elements of the application based on parameters fed by social networks, such as connections, likes, education, age, gender, location, language, hobbies, installed applications, and so on.

A social media platform (e.g., social-networking platform) is a platform through which people, groups, and/or businesses interact, and that is capable of facilitating social-networking advertisements and social-networking applications. Thus, a platform may present, or be associated with, advertisements and applications that are presented to its users. These advertisements and applications are associated with a platform in one or more of a variety of ways, such as being branded to that platform (e.g., Facebook™-branded game), being accessible through the platform (even if interactions are actually managed by a third party), or presented within the platform's user interface (e.g., an advertisement for a resume-drafting service presented within the LinkedIn™ interface), to name but three examples. Social networking applications act and interact with users of the platform, while advertisements generally present information, though advertisements may allow some interactions, such as a button to select more information.

As will be discussed in greater detail below, interaction data may be explicitly selected or implicitly deduced from acts of a user with a platform, advertisement, or application. Examples include a user's explicit selection to “like” a music group in the Facebook™ platform or “follow” a person in the Twitter™ platform. These are examples of explicit acts by the user that indicate a user's interest through some selection mechanism, such as through a button on the social-networking application or platform's user interface. Interaction data may also include a user's implicit interactions, such as to read a news article or buy a product.

Demographics are also discussed further below. Demographics include characteristics of persons, such as age, sex, ethnicity, country of origin, country of residence, and so forth. Populations can have, or be defined through, these characteristics, such as a population of a social-networking platform that are female, between 13 and 17 years of age, and reside in Portland, Oreg.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

As employed herein, the term “audience” may define a group of users having one or more common attributes, such as social parameters corresponding to a social media platform. By way of example and not limitation, an audience can define a group of users of a particular social media platform that like a particular product or company, that are between 18 and 30 years of age, and/or are interested in football. An audience can be defined as a group of users that have more than 50 “likes” for Facebook™, or have less than 30 connections in LinkedIn™. Thus, the audience can define any of a variety of groups of users of a social media platform.

The term “social parameters” may define any of a variety of information corresponding to a user of a social media platform. The information associated with a user can include demographic information, geographic information, psychographic information, behavioral information, and so on. Some examples may include “likes,” “dislikes,” education, gender, age, number of friends, profession, location, and so on.

As employed herein, the term “object” is representative of a location in memory having a value and referenced by an identifier. An object can be a data structure, a variable, a function, an instance of a class, a table, a column, an association between data and a database entity, and so on. Some examples of objects can include files, text, images, audio data, video data, audio/video data, and so on. Thus, the term “object” can represent any of a variety of objects.

As employed herein, the term “content” is representative of data, such as text content (e.g., messages), photographs, video, audio, and so on. Additionally, the content can include one or more objects. The content can be displayed for the user, and can be selectable by the user to perform one or more actions. Further examples of the above-described terms may be found in relation to the following discussion.

### Example Environment

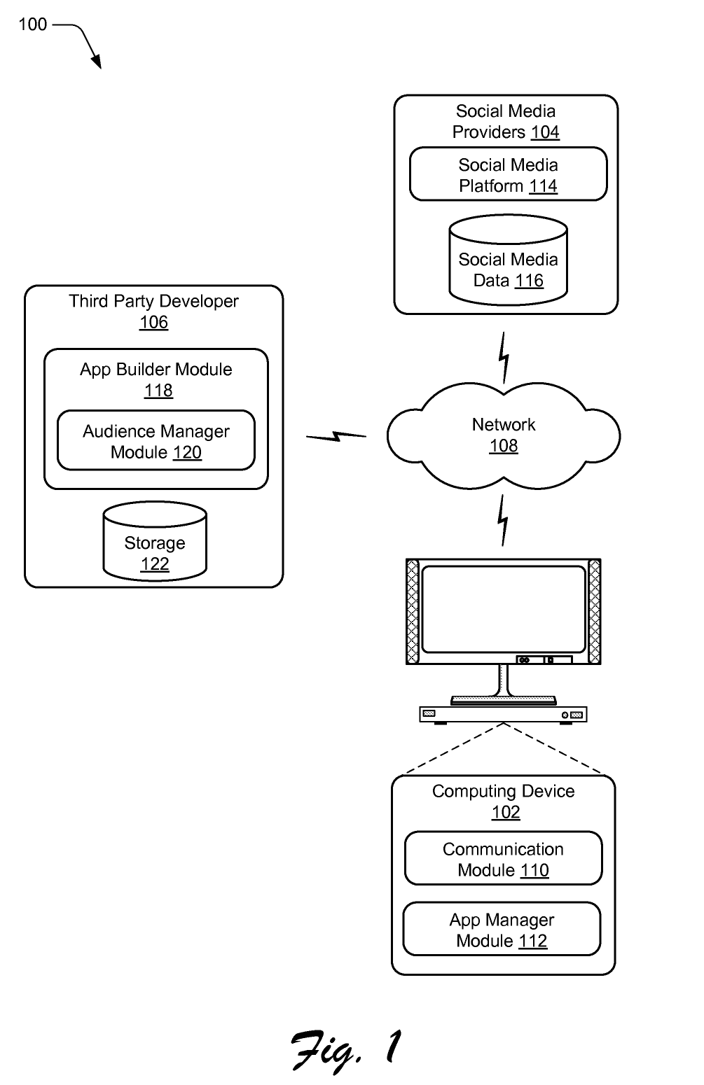

FIG. 1 is an illustration of an environment 100 in an example implementation that is operable to employ techniques described herein. The illustrated environment 100 includes a computing device 102, social media providers 104, and a third party developer 106 that are communicatively coupled via a network 108. In addition, the computing device 102 as well as computing devices that implement the social media providers 104 and the third party developer 106 may be configured in a variety of ways.

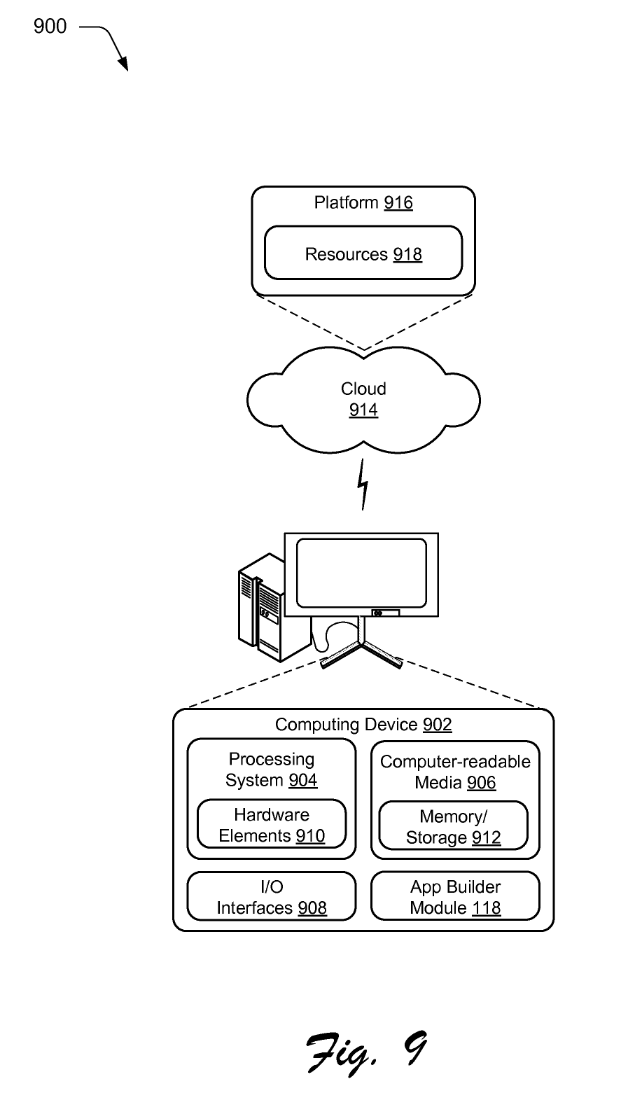

The computing devices, for example, may be configured as a desktop computer, a laptop computer, a mobile device (e.g., assuming a handheld configuration such as a tablet or mobile phone), and so forth. Thus, the computing devices may range from full resource devices with substantial memory and processor resources (e.g., personal computers, game consoles) to a low-resource device with limited memory and/or processing resources (e.g., mobile devices). Additionally, a computing device may be representative of a plurality of different devices, such as multiple servers of the service provider 104 utilized by a business to perform operations “over the cloud” as further described in relation to FIG. 9, a tablet and a peripheral device, and so on.

Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 108 may be representative of multiple networks.

The computing device 102 is also illustrated as including a communication module 110 and an application manager module 112. The communication module 110 is representative of functionality to communicate via the network 108, such as with one or more services of the social media providers 104. As such, the communication module 110 may be configured in a variety of ways. For example, the communication module 110 may be configured as a browser that is configured to “surf the web.” The communication module 110 may also be representative of network access functionality that may be incorporated as part of an application, e.g., to provide network-based functionality as part of the application, an operating system, and so on. Thus, functionality represented by the communication module 110 may be incorporated by the computing device 102 in a variety of different ways.

The application manager module 112 is representative of functionality to manage an application on the computing device 102. As such, the application manager module 112 may be configured in a variety of ways. For example, the application manager module 112 may be configured to identify various social parameters of a user of a social media platform, and provide an experience that is customized to the user based on the identified social parameters.

The social media providers 104 are representative of various enterprises and/or services that provide social media platforms 114 via which different users may interact and communicate. For instance, the social media platforms 114 can include web-based portals for social interaction. At least some of the social media platforms 114, for instance, can include webpages and/or web applications that enable users to view and post content.

Users can interact via the social media platforms 114. For instance, a user of computing device 102 can create accounts with different social media platforms 114. Utilizing the accounts, the user can post various types of content to the social media platforms 114, such as text content (e.g., messages), photographs, video, audio, and so on. The user can also utilize the social media platforms 114 to demonstrate an affinity for various content and/or entities, such as by indicating a preference (e.g., “liking”) for a particular instance of content, “friending” other users, “following” other users, and so on.

The third party developer 106 is illustrated as including an application builder module 118, an audience manager module 120, and storage 122. The application builder module 118 is representative of functionality to build an application, such as a web-based promotion or interactive application that can run on, or off of, a social network and/or on different social platforms. The application can also be viewed on a variety of different client devices. In addition, the application can be platform independent, such that the application is not limited to a single platform. Furthermore, the application can be delivered to the computing device 102 via the network 108, such as the Internet. In one embodiment, the application can be dependent on a particular social media platform, such that social media data can be pulled by the application manager module 112 from the social media platforms 114, and/or pushed to the application manager module 112 from the social media platforms 114. For example, the application may be dependent on the Facebook™ platform, the Twitter™ platform, the Instagram™ platform, the LinkedIn™ platform, or any other suitable social media platform.

The social media data 116 can include collections of information corresponding to users, such as user profiles, that are usable to track various types of data, such as user preferences, groups of other users known to interact with a particular user (e.g., “followers”), demographic information as described above, and so forth. The data can also include social parameters corresponding to the user of a particular social media platform.

A social parameter can include any of a variety of information corresponding a user of a social media platform, such as education, gender, age, number of friends, “likes,” profession, an indication that the user likes a certain company or brand but does not like that company's or brand's competition, and so on. The social parameters may be specific to a particular social media platform (e.g., number of “likes” for Facebook™, “endorsements” for LinkedIn™), or may be independent of the social media platform (e.g., demographic information for the user).

The audience manager module 120 is representative of functionality to define and manage one or more audiences for an application. For example, the audience manager module 120 may be configured to define an audience based on social media data 116, such as one or more social parameters, of a social media platform. By using these social parameters, the audience can define a group of users having common attributes. For instance, the application manager module 120 can parse the social media data 116 to identify keywords, sentiment information (e.g., likes/dislikes associated with different content and/or entities), geographical information (e.g., geographical location of residence of the user), and so on.

Once an audience is defined, the audience can be stored in storage 122 of the third party developer 106, and the application builder module 118 may associate the audience with particular content in the application to enable that particular content to be presented to a user having one or more social parameters corresponding to the audience. In contrast, a user that does not have a social parameter corresponding to the audience may not be presented with the particular content associated with the audience. Thus, the functionality represented by the audience manager module 120 may be incorporated by the third party developer 106 in a variety of ways, further discussion of which is provided below.

Once the application is created, the application can be transmitted to the computing device 102 via network 108. Subsequently, the application manager module 112 of the computing device 102 can perform in-application customizations of the application based on the predefined audiences and based on the social parameters of the user identified via the social media data 116 of the social media platform 114.

Having described example operating environments in which the inventive principles can be employed, consider now a discussion of various embodiments.

Application Builder Module

The following discussion describes example graphical user interfaces (GUIs) that can be employed to perform various aspects of techniques discussed herein in accordance with one or more embodiments. The example GUIs may be employed in the environment 100 of FIG. 1, the system 900 of FIG. 9, and/or any other suitable environment.

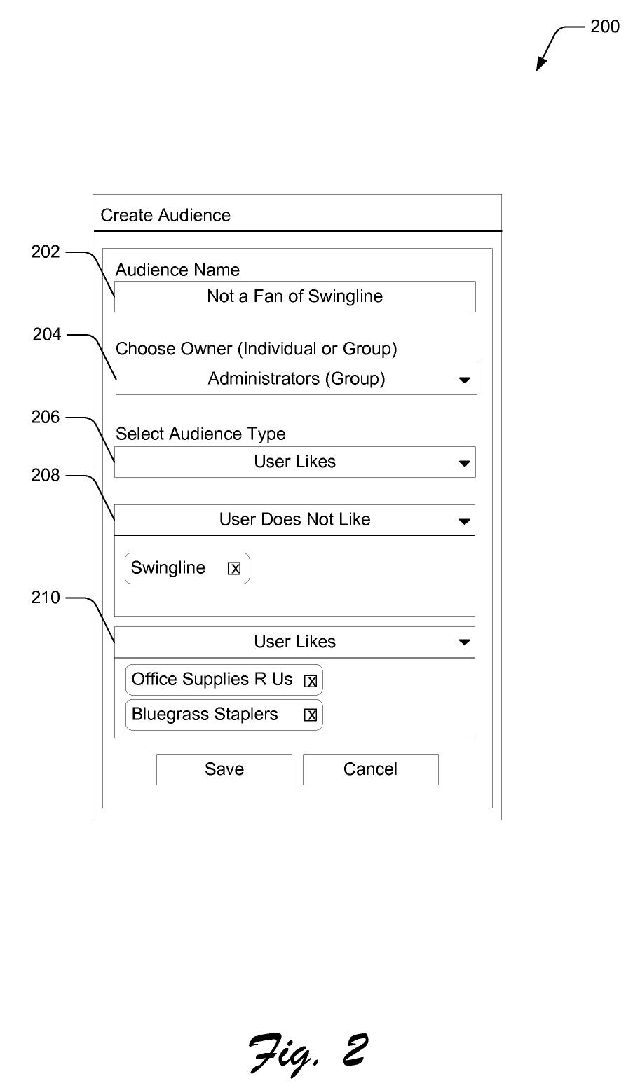

FIG. 2 is an illustration of an example graphical user interface (GUI) 200 that can be employed by the application builder module 118 of FIG. 1 to create and manage audiences defined by the audience manager module 120 of FIG. 1. The GUI 200 includes a variety of menus and/or fields that can receive user input to provide and configure parameters for defining an audience. For example, an audience may be created by at least defining a name 202, determining an owner 204 of the audience, and identifying one or more social parameters 208, 210 for the audience.

According to various embodiments, a name 202 can be defined for a new audience. The name can be any suitable name selected, by a user or automatically, to identify the audience. In the example shown in FIG. 2, the new audience is named “Not a Fan of Red-Stapler” to indicate that this new audience is intended to be defined for those users that dislike, or who are not a fan of, a stapler manufacturer company named Red-Stapler (referred to herein as “Red-Stapler”). In addition, one or more owners 204 can be designated to have administrator rights to the audience. Any suitable individual or group can be designated as the owner of the audience and given administrator rights to the audience. For example, the owner of the “Not a Fan of Red-Stapler” audience in FIG. 2 is designated as a group called Administrators. Thus, users with access rights to the Administrators group can have administrator rights to this particular audience.

The GUI 200 further includes one or more social parameters that can be selected to define an audience type 206. Any suitable social parameter can be used. By way of example and not limitation, social parameters can include attributes of the social media data 116 corresponding to the user, such as user education, gender, number of friends, profession, user likes, age, marital status, hobbies, affiliations, salary range, and so on. Continuing with the above example, an audience type 206 is selected to be “User Likes” to indicate various items, entities, products or services, or any other criteria that a particular user likes or does not like.

In at least one embodiment, one or more additional parameters 208, 210 can be selected to further define the audience. For example, additional parameters can include one or more values or range of values of the social parameter selected for the audience type 206. Some examples include, “some college,” “went to college,” “is an engineer,” “is male,” “is female,” “has more than 50 friends,” “likes fishing,” “likes mountain biking,” “likes football,” “is under 30 years old,” and so on. Any suitable value or range of values can be used to define a variety of parameters for the audience. In the example shown in FIG. 2, additional parameters 208 and 210 are selected to define users that do not like the Red-Stapler company but do like Red-Stapler's competitors, e.g., “Office Staplers R Us” and “Bluegrass Staplers.”

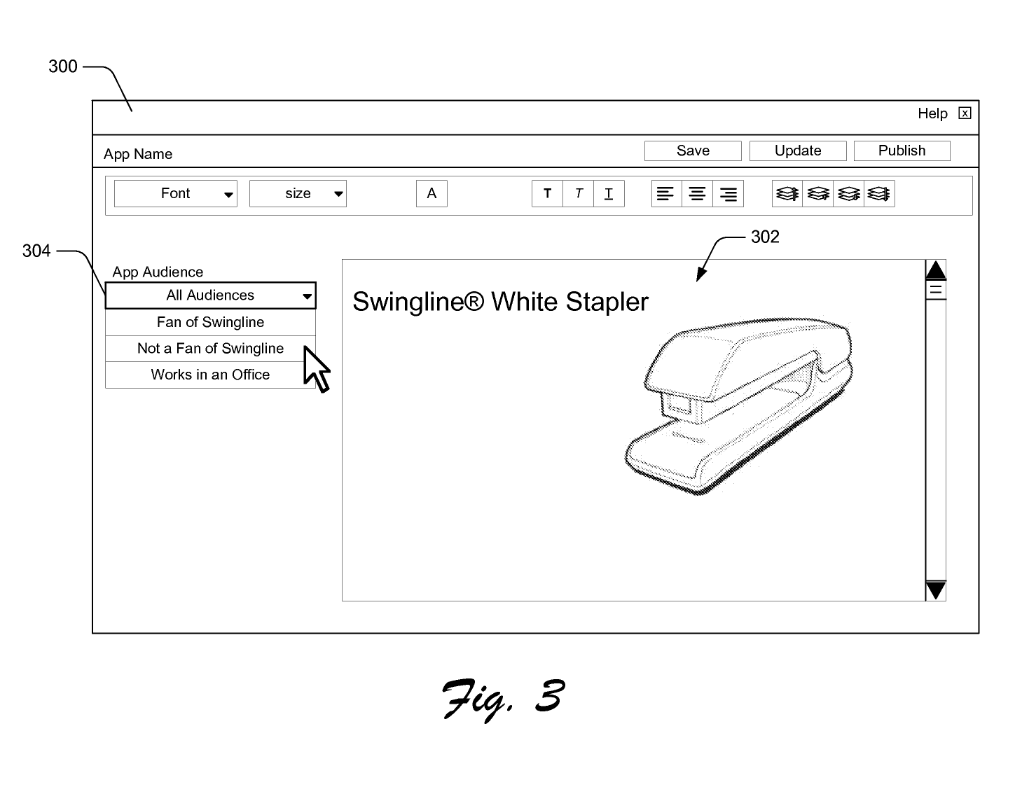

Having described a process to create audiences, consider now a discussion of a GUI that can be employed to build a new application using the above-described audiences to define various layouts of the new application. FIG. 3 is an illustration of an example GUI 300 that can be employed by the application builder module 118 of FIG. 1. When building an application, a user can define a layout of content in area 302 of the GUI 300. The layout of content may include one or more objects that are configured to be presented to a user of a client device using the application. Any suitable object can be used, such as for example, text, images, audio data, video data, and audio/video data. The user building the new application can select an application audience, such as the previously created audience described above in relation to FIG. 2, to change the view in area 302 to a layout of content associated with the selected audience, or to create a new layout of content.

In the example shown in FIG. 3, the application audience that is currently selected is titled “All Audiences” to indicate that the content displayed in area 302 is associated with all audiences thereby enabling the content to be included in views for each individual audience. However, the user can select any available audience from a menu or list of predefined audiences. For example, GUI 300 illustrates a cursor hovering over the “Not a Fan of Red-Stapler” audience, which can be selected by actuating an input device, such as a mouse button.

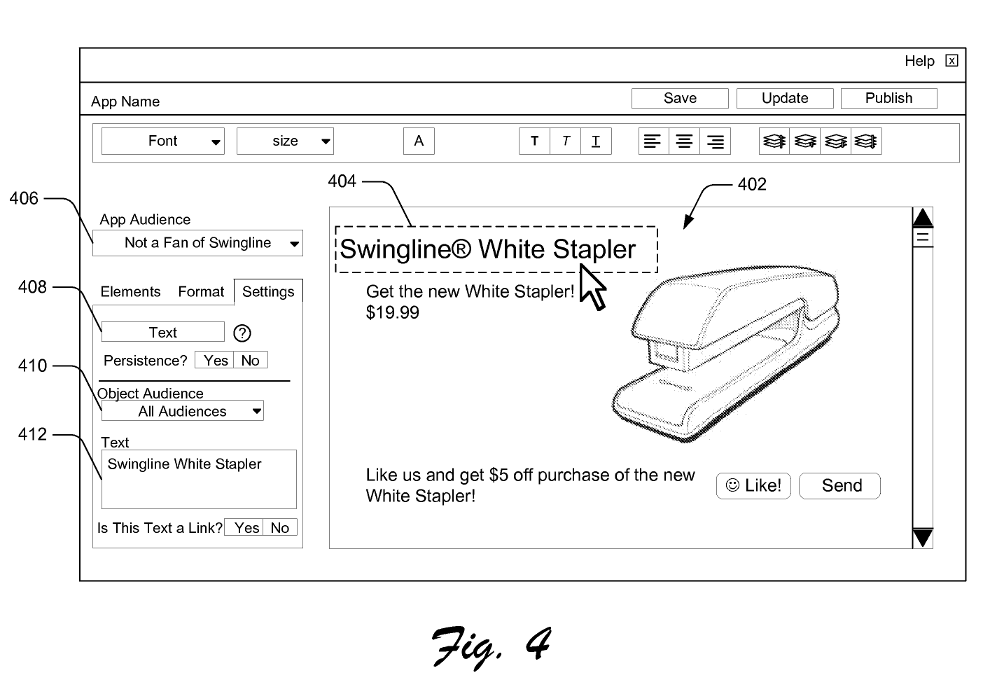

In response to selection of a different application audience, the content in area 302 is modified to display content associated with the selected application audience. Continuing with the above example, once the user selects the “Not a Fan of Red-Stapler” audience, the GUI 300 can be modified, as illustrated in GUI 400 of FIG. 4.

FIG. 4 is an illustration of an example GUI 400 that can be employed by the application builder module 118 of FIG. 1. The GUI 400 includes a layout of content in area 402 having a plurality of objects that are each associated with the selected application audience 406. The objects may also be associated with one or more other audiences. For example, object 404 may be associated with all audiences since the object includes a title for the page. An object may therefore be associated with an object audience, in addition to the application audience, that is associated with all content in a particular layout.

Upon selection of an object, one or more settings for the selected object may be presented. The settings may include a definition of the type of object, such as text, image, video, audio, link, and so on. Continuing with the example shown in FIG. 4, the object 404 (e.g., title) is selected, and is defined as text 408. In addition, the title is shown to be associated with an object audience 410 named “All Audiences,” which can enable the title to be maintained on the page regardless of which application audience is selected. This may prevent a developer from being forced to copy the title to each page for different audiences. In addition, the text of the title may be edited via box 412.

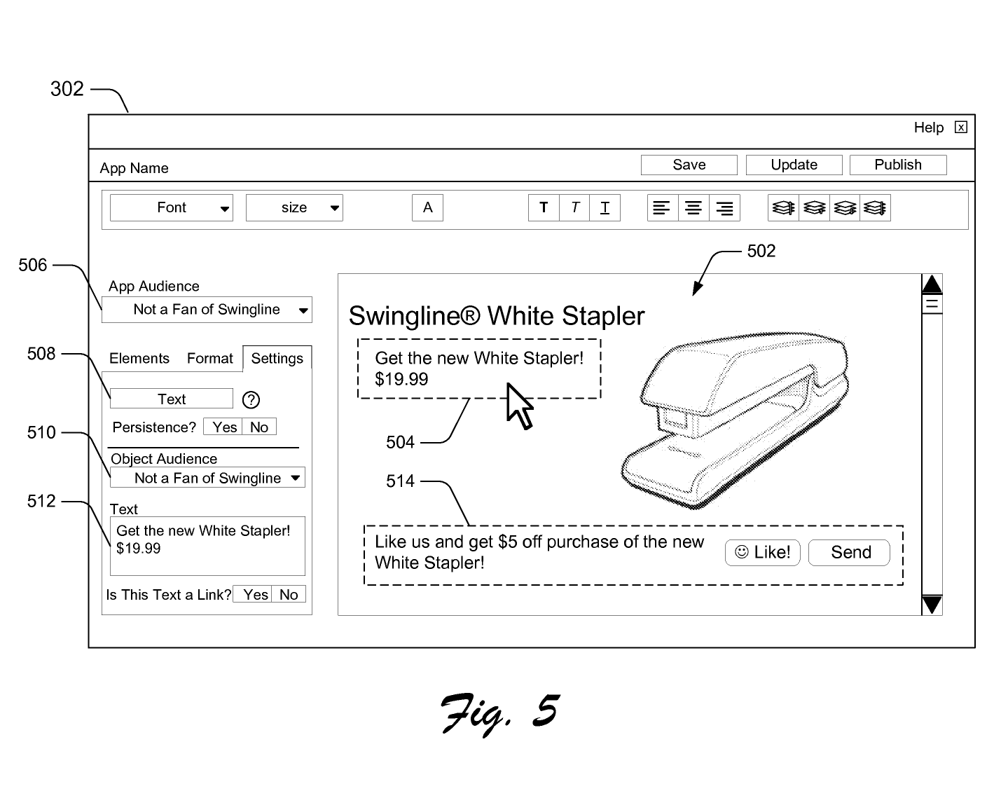

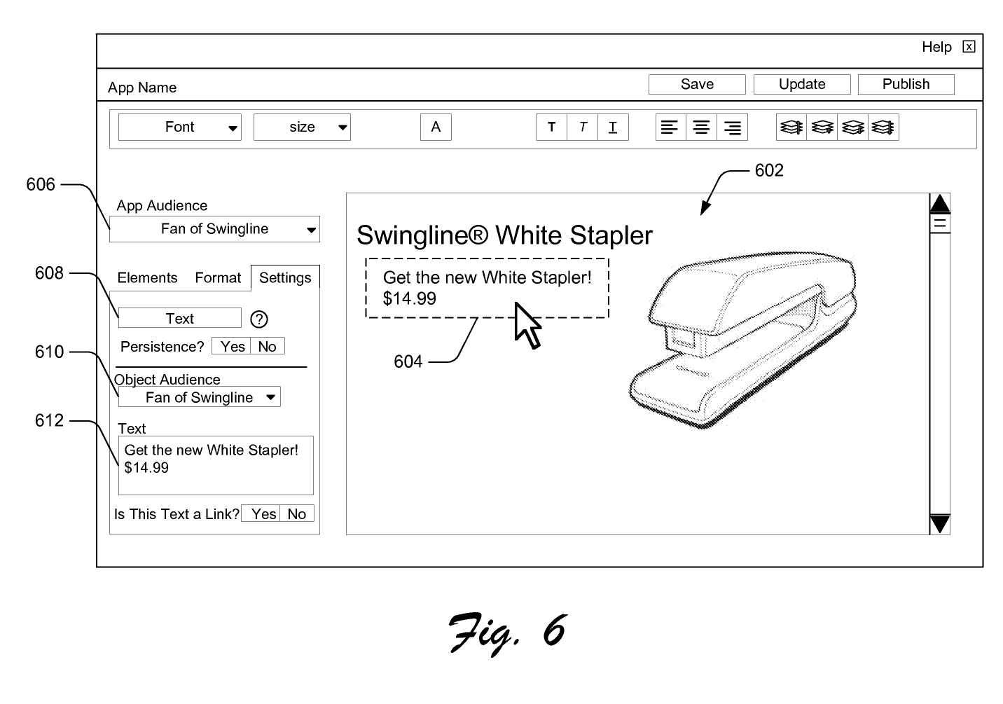

Consider now an example implementation of the application builder module 118 with respect to GUI 500 of FIG. 5 and GUI 600 of FIG. 6. In FIG. 5, the user has selected object 504. Object 504 is one of several objects in the layout of content in area 502 that are associated with the “Not a Fan of Red-Stapler” application audience 506. Further, object 504 is defined as text 508 and is associated with a “Not a Fan of Red-Stapler” object audience, which indicates that object 504 may not be displayed as part of a different object audience. In addition, object 504 includes text that can be modified via box 512, which states “Get the new White Stapler! $19.99.”

Because the layout of content in area 502 is associated with the “Not a Fan of Red-Stapler” application audience, the content may also include an option for a user to select to become a fan of Red-Stapler, such as to “like!”, “follow”, “endorse” and so on. In an embodiment, a user may be provided with an option to purchase a product or service at a discount price if the user “likes” a particular company or a particular product or service. For example, object 514 provides an option for a user to save $5 if the user selects a “Like!” button to become a fan of Red-Stapler.

Consider now FIG. 6, which is an illustration of an example GUI 600 that can be employed by the application builder module 118 of FIG. 1. The GUI 600 is designed to create a layout of content in area 602 that is configured to be presented to users that are fans of Red-Stapler. For example, if the user of computing device 102 is already a fan of Red-Stapler, or has selected the option to become a fan, then the layout of content in area 602 of FIG. 6 may be presented rather than the layout of content in area 502 of FIG. 5.

The layout of content in area 602 includes object 604 that indicates a reduced price of $14.99, in contrast to the $19.99 price of the stapler presented to non-fans of Red-Stapler. The objects included in the layout of content in area 602 are associated with a “Fan of Red-Stapler” application audience 606. Further, object 604 is defined as text 608 and is associated with a “Fan of Red-Stapler” object audience 610. In addition, the text of object 604 may be modified via box 614 by the user building the application. Notice that the layout of content in area 602 does not include an option to become a fan because this particular layout is configured to be presented to those users who are currently fans of Red-Stapler.

Having described various embodiments of example systems, consider now a discussion of various example procedures.

### Example Procedures

The following discussion describes techniques for social parameter-based application audiences that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1, and the graphical user interfaces of FIGS. 2-6.

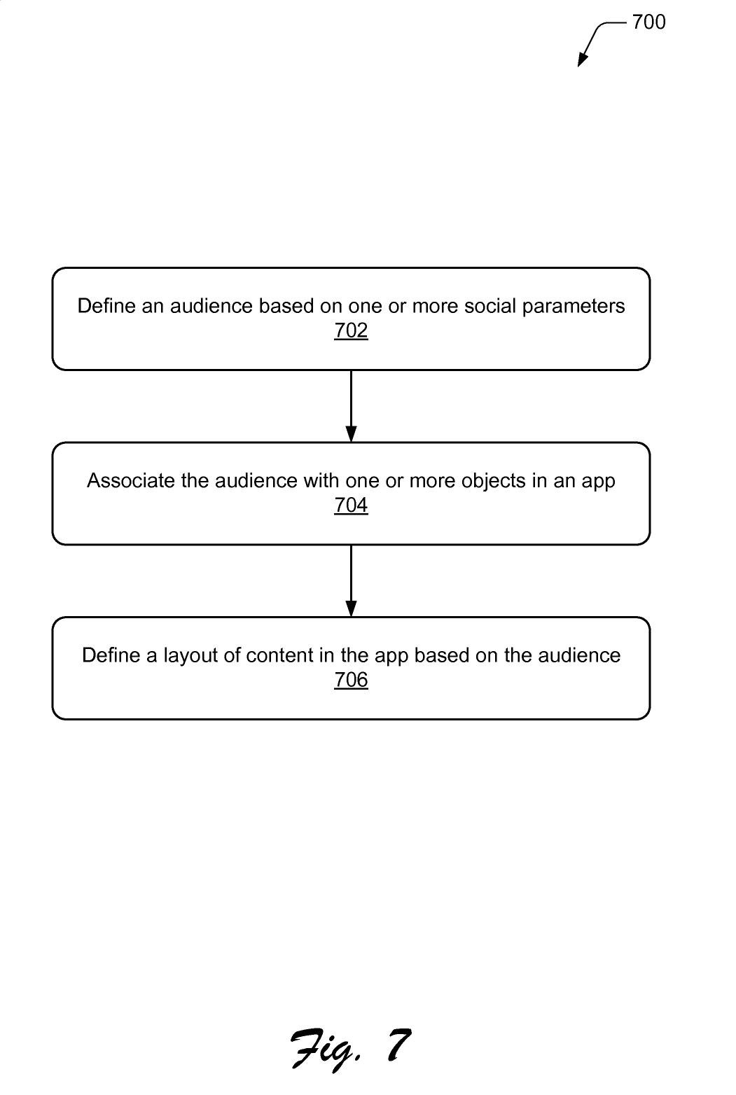

FIG. 7 is a flow diagram depicting a procedure 700 in an example implementation in which social parameter-based application audience techniques are employed. An audience is defined based on one or more social parameters (block 702). For example, the audience can be defined using an audience manager module 120 of FIG. 1, and can be defined as a group of users of a social media platform that have common attributes. The social parameters can include any of a variety of social parameters of users of the social media platform. The social parameters can include, but are not limited to, affiliations, hobbies, number of friends, marital status, salary range, gender, education, age, user likes, and so on. In addition, one or more values or range of values for one or more of the social parameters for the audience can be identified to further define the audience.

The audience is associated with one or more objects in an application (block 704). For example, each object in a layout of content or on a page of the application can be associated with a particular audience to enable particular objects to be presented to users of the application based on a particular audience to which those users correspond. A layout of content in the application is defined based on the audience (block 706). In at least one embodiment, an object such as an image may be associated with a “Not a Fan of Red-Stapler” audience to enable the image to be presented only to users of the application that are not fans of the Red-Stapler company. Thus, the image may not be presented to users that are fans of the Red-Stapler company, based on those users corresponding to a different audience, such as a “Fan of Red-Stapler” audience.

Using the above techniques, each audience in the application can bring a unique view for all screens of the application. Therefore, a user having social parameters corresponding to a first audience may have an entirely different experience on the same application as another user that has social parameters corresponding to a second audience. The audiences allow developers to create experiences that are customized for each user based on each user's own social parameters.

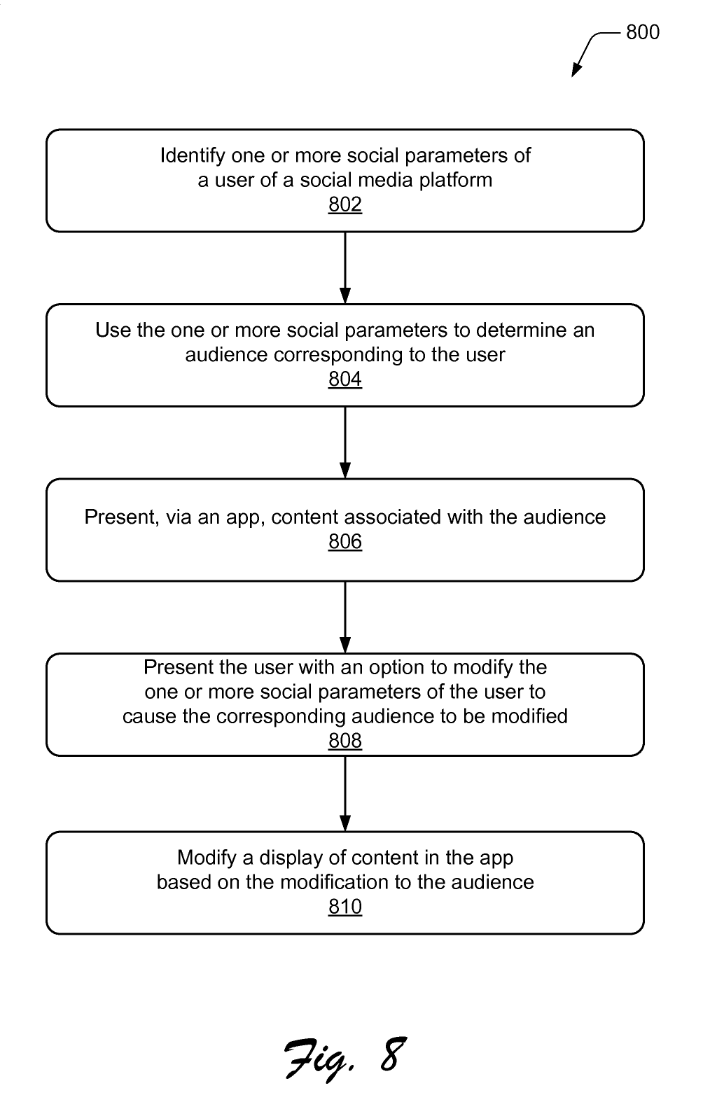

Having discussed a general procedure with respect to FIG. 7, consider now a discussion of FIG. 8, which a flow diagram depicting a procedure 800 in an example implementation in which social parameter-based application audience techniques are employed. One or more social parameters of a user of a social media platform are identified (block 802). In one or more embodiments, an application manager module 112 shown in FIG. 1 may be configured to retrieve social parameters of the user, either locally or remotely, based on the social media platform with which the application is associated.

An audience corresponding to the user is determined by using the one or more social parameters (block 804). For example, the application manager module 112 may use the identified social parameters to determine with which audience the user corresponds. In one or more embodiments, the social parameters may indicate that the user does not like Red-Stapler but does like one or more of Red-Stapler's competitors. Based on this information, the application manager module 112 can determine that the user corresponds to a “Not of Fan of Red-Stapler” application audience and a “Fan of Red-Stapler's competition” application audience.

Content associated with the audience is presented via an application (block 806). In one or more embodiments, the user's experience via the application is tailored to the user based on the audience to which the user corresponds. For example, content associated with the audience to which the user corresponds is presented to the user, and the user is not presented with content that is not associated with the audience. Continuing with the above example, the user may be presented with content that is associated with the “Not a Fan of Red-Stapler” application audience and the “Fan of Red-Stapler's competition” application audience. In this way, targeted advertisements or promotions can be presented to the user, such as a discount on a product or service associated with Red-Stapler where the discount is contingent upon the user becoming a fan of Red-Stapler.

The user is presented with an option to change one or more social parameters to cause the corresponding audience to be modified (block 808). In one or more embodiments, the user can be presented with an option to become a fan of, or to “Like!” a particular product, service, or company, if the user is not currently a fan. If the user opts to “like!” the product, service, or company, then the user's social parameters can be modified, thereby causing a change to the corresponding audience.

A display of content in the application is modified based on a modification to the audience (block 810). For example, if the user becomes a fan of Red-Stapler, then the user's social parameters can be modified. Consequently, the audience to which the user corresponds can be modified from the “Not a Fan of Red-Stapler” application audience to the “Fan of Red-Stapler” application audience, and the content displayed for the user can also be modified according to the “Fan of Red-Stapler” application audience.

Using the above described techniques, different users of the application can be provided different experiences based on the social parameters of each user. In addition, these different experiences provided via the application can be more easily designed by third party developers for social media platforms than by using traditional techniques.

### Example System and Device

FIG. 9 illustrates an example system generally at 900 that includes an example computing device 902 that is representative of one or more computing systems and/or devices that may implement the various techniques described herein. This is illustrated through inclusion of application builder module 118, which may be configured to utilize social parameter-based application audiences when building an application, and application manager module 112, which may be configured to manage the application on the computing device 902 based on social parameters of a user of the social media platform. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

The techniques described herein may be supported by various configurations of the computing device 902 and are not limited to the specific examples of the techniques described herein. This functionality may also be implemented all or in part through use of a distributed system, such as over a “cloud” 914 via a platform 916 as described below.

Cloud 914 includes and/or is representative of a platform 916 for resources 918. Platform 916 abstracts underlying functionality of hardware (e.g., servers) and software resources of the cloud 914. Resources 918 may include applications and/or data that can be utilized while computer processing is executed on servers that are remote from the computing device 902. Resources 918 can also include services 920 provided over the Internet and/or through a subscriber network, such as a cellular or Wi-Fi network.

Platform 916 may abstract resources and functions to connect computing device 902 with other computing devices. Platform 916 may also serve to abstract scaling of resources to provide a corresponding level of scale to encountered demand for resources 918 that are implemented via platform 916. Accordingly, in an interconnected device embodiment, implementation of functionality described herein may be distributed throughout system 900. For example, the functionality may be implemented in part on computing device 902 as well as via platform 916 that abstracts the functionality of cloud 914.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
defining, by a computing device, an audience based on one or more social parameters;
associating, by the computing device, the audience with one or more objects in an application; and
defining, by the computing device, a layout of content in the application based on the audience, the content including the one or more objects that are associated with the audience, the layout of content being configured to be presented for display to a user having a social parameter that corresponds to the audience.

2. A method as recited in claim 1, wherein the audience defines a group of users having the one or more social parameters as a common attribute.

3. A method as recited in claim 1, wherein the associating of the audience with one or more objects in the application is performed during an application building phase of an application.

4. A method as recited in claim 1, wherein different users are presented with different content in the application based on the different users corresponding to different said audiences.

5. A method as recited in claim 1, wherein the one or more objects are configured to be associated with multiple said audiences.

6. A method as recited in claim 1, wherein an additional user that does not have a social parameter corresponding to the audience is not presented with the one or more objects.

7. A method as recited in claim 6, wherein:
the one or more objects is a product or service; and
the user that does not have a social parameter corresponding to the audience is presented with an option to purchase the product or service at a reduced price if the user opts to become a fan of one or more of the product or service or an entity that sells or manufactures the product or service.

8. A method as recited in claim 1, wherein the application comprises a native application that is configured to install on a client device.

9. A method as recited in claim 1, wherein the one or more social parameters include one or more of age, gender, education, number of friends, hobbies, affiliations, or user likes.

10. A method as recited in claim 1, wherein the one or more social parameters indicate that the user is a fan of a particular company or brand, and not a fan of a competitor of the particular company or brand.

11. A method as recited in claim 1, wherein the one or more objects includes a particular product at a reduced price.

12. A method as recited in claim 1, wherein the application is platform independent.

13. A method as recited in claim 1, wherein the application is dependent on a particular social media platform.

14. One or more computer readable storage media having instructions that, responsive to execution by a computing device, cause the computing device to perform operations including:
identifying one or more social parameters of a user of a social media platform;
using the one or more social parameters to determine an audience corresponding to the user; and
presenting, via an application, content associated with the audience.

15. One or more computer readable storage media as recited in claim 14, wherein the operations further include providing, via a same application, a different experience to different users that correspond to different said audiences.

16. One or more computer readable storage media as recited in claim 14, wherein the operations further include modifying a display of the one or more objects in the application based on a change to the audience, the change to the audience being based on a modification to the one or more social parameters of the user.

17. One or more computer readable storage media as recited in claim 14, wherein the operations further include presenting the user with an option to modify the one or more social parameters of the user to cause the corresponding audience to be modified.

18. One or more computer readable storage media as recited in claim 14, wherein the operations further include the application comprises a web-based promotion or interactive application that can run on different social platforms.

19. A system comprising:
a memory and a processor configured to utilize instructions in the memory to implement an application builder module, the application builder module configured to:
define multiple different layouts of content for an application each corresponding to a respective audience, each respective audience being associated with one or more social parameters of users of a social media platform, the application being configured to provide different content to different users of the application based on the different users corresponding to different audiences.

20. A system as recited in claim 19, wherein the application builder module is usable by an entity other than a social media provider facilitating the social media platform.
